(19) United States
(12) Patent Application Publication
(10) Pub. No.: US 2025/0213927 A1
(43) Pub. Date: Jul. 3, 2025

(54) GOLF BALL PRINTING SYSTEM

(71) Applicant: Acushnet Company, Fairhaven, MA (US)

(72) Inventors: Edward Costa, Providence, RI (US); Erin C. McDermott, Providence, RI (US); Manjari Kuntimaddi, Raynham, MA (US)

(73) Assignee: Acushnet Company, Fairhaven, MA (US)

(21) Appl. No.: 18/397,532

(22) Filed: Dec. 27, 2023

(51) Int. Cl. A63B 37/00; A63B 45/02

(52) U.S. Cl. CPC A63B 37/00221; A63B 37/00223; A63B 45/02

(57) ABSTRACT

A golf ball printing system has a support mechanism configured to hold a golf ball. The golf ball printing system also has a motion device configured to rotate the golf ball about an axis of rotation and a rotation control device configured to vary the axis of rotation. The golf ball printing system additionally has a printing device having a marking tool configured to remain stationary while applying marking material to the golf ball while the golf ball is held in the support mechanism. The motion device is configured to rotate the golf ball while the marking tool applies marking material to the golf ball to produce a marking pattern on the golf ball.

### FIELD OF THE INVENTION

The present disclosure relates generally to a printing system, and, more particularly, to a system for printing on a golf ball by rotating the golf ball while in contact with a stationary marking tool.

### BACKGROUND OF THE INVENTION

Golf balls often include printed markings at various locations on the surface. There are several printing methods for applying the markings, including pad printing and laser jet printing, for example. Some current printing processes require an operator to manually change the position of a golf ball in order to enable printing of complex markings. In another example, a stationary golf ball may receive a stamp at different sites via multiple spaced printing elements in order to produce an elongated marking pattern that covers more than an area that can be reached by a single printing pad. These and other conventional methods can be inefficient and inadequate to accomplish some marking designs. For example, it may be difficult to seamlessly connect parts of a multi-stamp marking pattern with adequate alignment. The present disclosure is directed to systems and methods for efficiently printing simple and complex marking patterns on golf balls.

### SUMMARY OF THE INVENTION

According to some embodiments, the present disclosure is directed to a golf ball printing system. The golf ball printing system includes a support mechanism configured to hold a golf ball. The golf ball printing system also includes a motion device configured to rotate the golf ball about an axis of rotation and a rotation control device configured to vary the axis of rotation. The golf ball printing system additionally includes a printing device including a marking tool configured to remain stationary while applying marking material to the golf ball while the golf ball is held in the support mechanism. The motion device is configured to rotate the golf ball while the marking tool applies marking material to the golf ball to produce a marking pattern on the golf ball.

According to some other embodiments, the present disclosure is directed to a method of printing a marking on a surface of a golf ball. The method includes receiving, at a design system comprising a processing unit, an intended design for a golf ball marking. The intended design including at least a shape of the marking and a position of the marking on the golf ball. The method also includes generating, by the processing unit, a marking plan based on the shape and position of the golf ball marking of the intended design, wherein the marking plan includes rotation instructions. The method also includes placing the golf ball in a support mechanism connected to a motion device configured to rotate the golf ball, placing the golf ball in contact with a stationary marking tool, and rotating the golf ball with the motion device based on the rotation instructions to produce the golf ball marking on the golf ball.

According to some further embodiments, the present disclosure is directed to a golf ball printing system. The golf ball printing system includes a design system including a central processing unit and a modeling unit, the modeling unit configured to receive an intended design of a marking pattern and generate a marking plan comprising rotation instructions and print instructions. The golf ball printing system also includes a rotation device connected to the design system and configured to rotate a golf ball about a variable axis of rotation based on the rotation instructions. The golf ball printing system further includes a printing device comprising a marking tool configured to apply marking material to the golf ball while the golf ball is rotated by the rotation device. The golf ball printing system also includes a start-stop device connected to the control unit and configured to start and stop the application of the marking material based on the print instructions.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a first example of a golf ball having a continuous linear marking;

FIG. 2 is a process flow through an exemplary golf ball printing system, consistent with disclosed embodiments;

FIG. 3 is a diagram of the golf ball printing system, consistent with disclosed embodiments;

FIG. 4 is an illustration of an exemplary embodiment of the golf ball printing system;

FIG. 5A is an example of a golf ball having a continuous linear marking with lines extending in different directions;

FIG. 5B is an example of a golf ball having a continuous curvilinear marking;

FIG. 5C is another example of a golf ball having a continuous curvilinear marking; and

FIG. 5D is an example of a golf ball having a non-continuous linear marking.

### DETAILED DESCRIPTION OF THE INVENTION

The present disclosure relates to a printing system and associated methods of printing. The disclosed embodiments may be particularly applicable to printing on a spherical object, such as a surface of a golf ball. In disclosed embodiments, a printing system includes a stationary marking tool and a rotation device configured to rotate a golf ball relative to the marking tool. The marking tool applies marking material (e.g., ink) to the golf ball while the golf ball is rotating, thereby printing a marking pattern onto a surface of the golf ball. The printing system may also be configured to vary the axis of rotation of the golf ball, thereby enabling the printing of complex marking patterns in a quick and efficient manner.

The printing system includes an action system for printing on a golf ball. The action system includes the rotation device and the marking tool, and may comprise other features such as a start/stop device, tool control device, and a support mechanism. In some embodiments, the printing system includes a design system configured to receive an intended design and generate a marking plan for printing a marking pattern that matches the intended design on a golf ball. The marking plan may be comprised of rotation instructions and/or print instructions for controlling components of the action system in order to print the marking pattern on the golf ball.

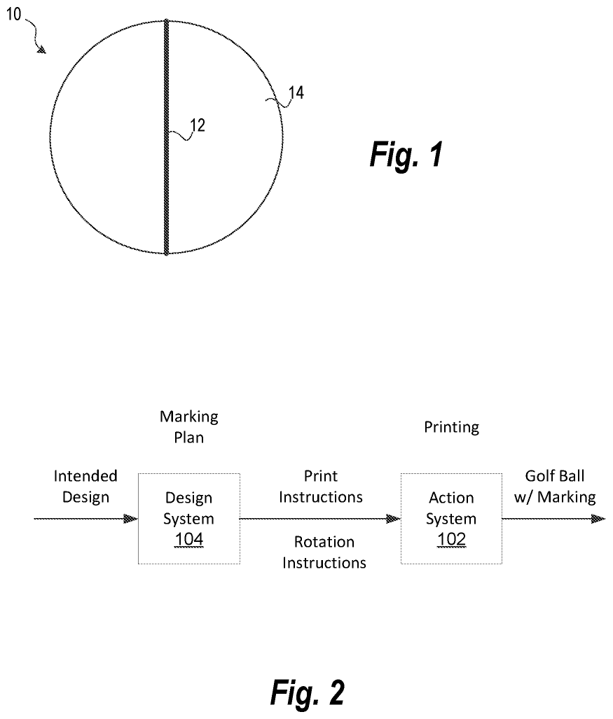

FIG. 1 is a golf ball 10 having a marking pattern 12 printed on a surface 14 thereof. The marking pattern 12 is an example of a continuous linear marking. The marking pattern 12 extends around a great circle of the golf ball 10. In disclosed embodiments, a printing system can produce linear markings that extend around a portion of the golf ball that is greater than what can be reached by a conventional pad print or laser jet printing system in one printing step on a stationary golf ball. For example, the marking pattern 12 extends at least 120 degrees around a great circle on the surface 14 of the golf ball 10. The surface 14 may be the surface of any layer of the golf ball 10, such as a cover layer, paint layer, topcoat layer, core layer, casing layer, etc. The golf ball 10 may be a finished golf ball or a golf ball subassembly (e.g., core, cased core, etc.).

FIG. 2 is schematic diagram of a golf ball printing system 100 for applying a marking pattern to a layer of a golf ball, such as the marking pattern 12 to the golf ball 10. In an exemplary embodiment, the golf ball printing system 100 includes an action system 102 and a design system 104. The action system 102 includes components configured to perform a printing operation. The design system 104 includes components configured to instruct the action system 102 to perform the printing operation in a manner that results in a golf ball having a marking pattern that matches an intended design.

FIG. 2 also illustrates a exemplary process flow for printing an intended design on a golf ball using the golf ball printing system 100. The process includes inputting an intended design into the design system 104. In one example, an intended design may be created using design software on the design system 104. In one example, the intended design is provided to the design system 104 as a design file. For example, the design system 104 may be configured to receive a .STL file. In an exemplary embodiment, the design file includes data that is representative of at least a shape and position of a marking pattern on a golf ball. In some embodiments, the design file includes data related to the shape, size, color, and position of a marking pattern on a golf ball. The shape, size, and color data indicate an intended appearance of the marking pattern. The position data may include relative position of the marking pattern in relation to other points on the golf ball, such as other markings that are already present on the golf ball (side stamps, play numbers, etc.).

The design system 104 is configured to analyze the intended design and produce a marking plan for printing the intended design on a golf ball using the action system 102. The marking plan may include rotation instructions and print instructions. The rotation instructions provide steps for rotating a golf ball in relation to a marking tool to produce a marking pattern that matches the intended design. The print instructions are additional steps for printing the marking pattern, such as start/stop instructions for controlling the timing of printing relative to the rotation of the golf ball, and marking tool control instructions for changing an aspect of the marking tool, such as color, size, etc. The action system 102 is configured to receive the marking plan and execute the associated instructions via a processing unit to perform a printing operation that results in a golf ball having a marking pattern that matches the intended design.

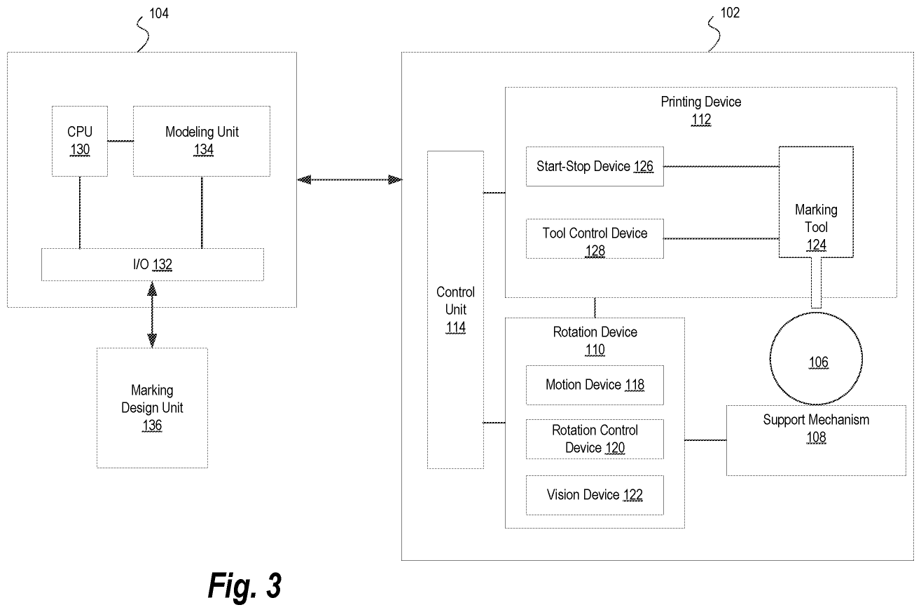

FIG. 3 is another diagram of the exemplary golf ball printing system 100. The golf ball printing system 100 includes the action system 102 and the design system 104. The action system 102 includes components configured to print a marking pattern on a golf ball 106. In an exemplary embodiment, the action system 102 includes a support mechanism 108, a rotation device 110, a printing device 112, and a control unit 114. The support mechanism 108 is configured to hold the golf ball 106 in position. The rotation device 110 is configured to rotate the golf ball 106 around an axis of rotation. The printing device 112 is configured to apply marking material to the golf ball 106 while the golf ball 106 is being rotated by the rotation device 110. Examples of marking material include ink, paint, primer, etc. The control unit 114 is a processing unit configured to control at least the rotation device 110 and the printing device 112 in order to print a marking pattern that matches an intended design. The control unit 114 may be a computing device such a processing unit and memory device configured to receive data from the design system 104 and execute software instructions to control the rotation device 110 and the printing device 112.

In an exemplary embodiment, the rotation device 110 includes a motion device 118, a rotation control device 120, and a vision device 122. The motion device 118 is configured to rotate the golf ball 106 about an axis of rotation. For example, the motion device 118 may be a motor configured to rotate the support mechanism 108 holding the golf ball 106. The rotation control device 120 is configured to vary the axis of rotation of the golf ball 106. While the axis of rotation of the support mechanism may remain constant, if the golf ball 106 changes position with respect to the support mechanism 108, the axis of rotation of the golf ball 106 is changed. The rotation control device 120 is thus configured to rotate the golf ball 106 relative to the support mechanism 108, to thereby change the axis of rotation of the golf ball 106.

The combination of the motion device 118 and the rotation control device 120 is configured to manipulate the golf ball 106 through multiple degrees of freedom in order to enable complex rotations of the golf ball 106 relative to the printing device 112. In some embodiments, the motion device 118 and the rotation control device 120 is a combined device, such as an orienting device configured to rotate a spherical object while sequentially or continuously varying the axis of rotation.

In some embodiments, the rotation control device 120 may be a second motion device configured to rotate the golf ball 106 about a second axis of rotation that thereby changes the axis of rotation of the golf ball 106 by the motion device 118. In some embodiments, the rotation control device 120 is configured to continuously vary the axis of rotation of the golf ball 106 by the motion device 118. For example, the rotation control device 120 may be configured to contact the golf ball 106 while it is being rotated by the motion device 118 in order to cause the golf ball 106 to change position relative to the support mechanism 108 and thereby change the axis of rotation of the golf ball 106 by the motion device 108.

The vision device 120 is configured to detect a position of the golf ball 106 relative to the support mechanism 108 and provide feedback to the control unit 114. The vision device 120 may be a camera or other sensor configured to identify a positional marking on the golf ball 106, such as an aspect of a dimple pattern, parting line, false parting line, or existing marking such as side stamp, play number, etc., that indicates the position of the golf ball 106 in the support mechanism 108. The control unit 114 may be configured to receive position data from the vision system 120 and provide instructions to the motion device 118 and/or rotation control device 120 in order to place the golf ball 106 in an initial position prior to printing via the printing device 112. In this way, the vision device 120 enables oriented printing on the golf ball 106 such that a marking pattern can be applied at a desired position on the golf ball 106. For example, a marking pattern may be printed at a location specified between markings already present on the golf ball 106.

The printing device 112 includes components configured to apply marking material to the golf ball 106 while the golf ball 106 is being rotated by the rotation device 110. In an exemplary embodiment, the printing device 112 includes a marking tool 124. The marking tool 124 is configured to remain stationary while applying marking material to the golf ball 106 while the golf ball 106 is held in the support mechanism 108. For example, the marking tool 124 may be an ink-holding marking tip configured to contact a surface of the golf ball 106 while the golf ball 106 is held by the support mechanism 108. The marking tip, like a brush or pen, contacts and applies ink or other marking material onto the surface of the golf ball 106 as the golf ball 106 rotates. In another embodiment, the marking tool 124 may be an ink dispenser that projects or sprays marking material onto the surface of the golf ball 106 as the golf ball 106 rotates.

In some embodiments, the printing device 112 further includes a start-stop control device 126 and a tool control device 128. The start-stop control device 126 is configured to control the marking tool 124 in order to start and stop the application of printing material. For example, the start-stop device 126 may control intervals of starting and stopping the application of the marking material while the golf ball 106 is rotating in order to produce a non-continuous marking. In some embodiments, the start-stop control device 126 may be configured to move the marking tool 124 out of contact with the golf ball 106 (or move the golf ball 106 out of contact with the marking tool 124). In another example, the start-stop mechanism 126 is configured to send a control instruction to start or stop application of marking material by an ink dispenser.

The tool control device 128 is configured to further control the marking tool 124. For example, the tool control device 128 may be configured to adjust the marking tool 124 in order to change a size or color of a marking tip in order to change the size, shape, and/or color of the marking material applied to the golf ball 106. The start-stop device 126 and tool control device 128 thereby enable the printing of detailed marking patterns that may be linear, curvilinear, continuous, or non-continuous, and may include different shapes, sizes, and colors.

The design system 104 comprises and/or is configured to interface with a computing system configured to modify an intended design to create a marking plan to send to the action system 102, as described herein. For example, the design system 104 may include a central processing unit (CPU) 130, an input/output (I/O) unit 132, and a modeling unit 134. In some embodiments, the design system 104 includes or interfaces with a mark design unit 136. The design system 104 is configured to receive an intended design and output a marking plan. For example, the modeling unit 134 may be configured to receive an intended design, determine rotation instructions for the rotation device 110 and printing instructions for the printing device 112 that when executed by the action system 102, produce a marking pattern on the golf ball 106 that matches the intended design. In one example, the modeling unit 134 may be configured to receive at least shape and position information of an intended design and generate rotation instructions and printing instructions based on the shape and position information. The modeling unit 134 may consider other data, such as size and/or color information, to further determine rotation instructions and/or printing instructions. The design system 104 is configured to send the rotation instructions and the printing instructions to the action system 102.

In an exemplary embodiment, the mark design unit 136 is configured to receive and/or generate a design file. The design file includes data that is representative of a shape, size, color, and/or position of an intended design for a marking pattern. In one example, the design file is an .STL file or similar file type that includes 3-D modeling and/or 3-D printing data. The mark design unit 136 may be a hardware and/or software component including a modeling program enabling a user to input an intended design. In some embodiments, the mark design unit 136 may be configured to receive an image of an intended design.

The modeling unit 134 may be configured to analyze the design file to determine the steps of golf ball rotation relative to the marking tool 124 and adjustments to the marking tool 124 that would produce the intended design represented in the design file. For example, in order to print the marking pattern 12 of FIG. 1, the modeling unit 134 may determine that the golf ball should be rotated around a single axis of rotation for a length of time and/or degree of rotation to produce a continuous linear marking around a great circle of the golf ball. For more complex designs, the modeling unit 134 may further determine values for rotation timing, variance in the axis of rotation, color changes, etc.

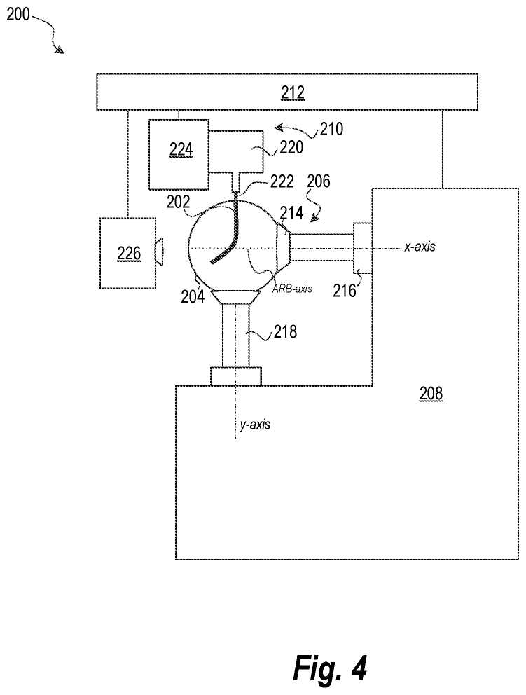

FIG. 4 is an illustration of an exemplary action system 200, consistent with disclosed embodiments. The action system 200 is configured to print a marking pattern 202 on a golf ball 204 based on a marking plan. The marking plan may be executable software instructions that cause the action system 200 to print the marking pattern 202. For example, the action system 200 may be configured to receive a marking plan comprised of rotation instructions and print instructions from a design system, such as the design system 104 in FIG. 3. The action system 200 includes a support mechanism 206, a rotation device 208, a printing device 210, and a control unit 212.

The support mechanism 206 may include a plurality of interconnected components configured to move relative to a stationary component, such as a housing or another mounting element shown or not shown. The support mechanism 206 includes at least a support member 214 configured to contact the golf ball 204. The support member 214 may include a cradle or cup configured to contact and secure the golf ball 204. The support member 214 may further include a rotatable shaft connected to the cradle or cup. The support member 214 may be configured to rotate about an x-axis to correspondingly rotate the golf ball 12 about a golf ball axis of rotation ARB. The ARB-axis is defined herein as the axis of rotation of the golf ball 204 as it is positioned relative to the support member 214. Thus, if the position of the golf ball 204 changes relative to the support member 214, the ARB-axis changes (i.e., a different axis of the golf ball becomes aligned with the x-axis).

The support mechanism 206 may be configured to hold the golf ball 204 in a selected position and/or orientation. For example, the support mechanism 206 may be configured to produce a holding force (e.g., a suction force) to hold the golf ball 204 relative to the support member 214. The holding force may be variable in order to enable the golf ball 204 to slip or move relative to the support mechanism 206, to thereby enable varying of the ARB-axis.

The rotation device 208 is configured to produce rotational movement of the support member 214 (and, by extension, the golf ball 204). The rotation device 208 may include a motor 216 configured to apply a rotational force on the support member 214. For example, the motor 216 may be configured to rotate the support member 214 about the x-axis.

The rotation device 208 may also include a second support mechanism 218 configured to contact the golf ball 204 and move the ball relative to the support member 214. For example, the second support mechanism 218 may include a second motor configured to rotate the second support mechanism 218 around the y-axis. In other embodiments, the second support member 214 may simply contact the golf ball 204 to adjust the golf ball 204 relative to the support mechanism 206. By changing the position of the golf ball 204 relative to support mechanism 206, the rotation device 208 is further configured to change the ARB-axis of the golf ball, thereby enabling more complex movement and positioning of the golf ball 204 during printing.

The printing device 210 is configured to apply marking material to the golf ball 204 while the golf ball 204 is being moved by the rotation device 208. The printing device 210 includes a marking tool 220 having a marking tip 222 that acts as a brush or pen tip that contacts the golf ball 204 and deposits marking material (e.g., ink, paint, etc.) via movement of the golf ball 204 while in contact with the marking tip 222. The printing device 210 includes a control mechanism 224 that may include a start-stop device and/or tool control device to adjust the marking tip 222 as needed during printing. The control mechanism 224 may be electronically connected to the control unit 212.

The control unit 212 is connected to the rotation system 208 and the printing system 210 and is a computing component configured to execute software instructions to cause the rotation system 208 and/or the printing system 210 to carry out an operation. For example, the control unit 212 may include a plurality of electronic components providing instructions to controllable components of the action system 200. For example, the control unit 212 may include at least one processor, at least one memory, and at least one I/O device. The memory may store instructions to be executed by the processor in order to cause the action system 200 to perform a task related to one or more golf balls. For example, the control unit 212 may execute a control process to receive, position, orient, and hold a golf ball for printing. More particularly, the control unit 212 may include a rotation control module to start and stop the motor 216. Further, the control unit 212 may further include an axis control module configured to cause the rotation device 208 to vary the ARB-axis of the golf ball 204. In addition, the control unit 212 may include a print control module configured to adjust the marking tip 222 in order to control the application of marking material while the golf ball 204 is rotating.

In some embodiments, the action system 200 may further include a vision device 226 configured to detect a position of the golf ball 204 relative to the rotation device 208. The vision device 226 may be electronically connected to the control unit 212. The vision device 226 may provide visual feedback to the control unit 212 regarding the position of the golf ball 204. In some embodiments, the action system 200 may be configured to operate in an oriented printing mode such that the marking pattern 202 is applied to a particular location on the golf ball 204 by first orienting the golf ball 204 via the rotation device 208 before printing. For example, the rotation device 226 may rotate the golf ball 204 until the vision device 226 detects that the golf ball 204 is in a selected starting position. In some embodiments, the vision device 226 may monitor a printing operation and provide feedback control for a more accurate printing operation.

Disclosed embodiments include a printing system for printing a marking pattern on a golf ball using a stationary marking tool and a moving golf ball. The disclosed printing system enables efficient and detailed printing of various types of marking patterns, including larger marking patterns that cover a portion of the golf ball that would be difficult to produce using other printing methods.

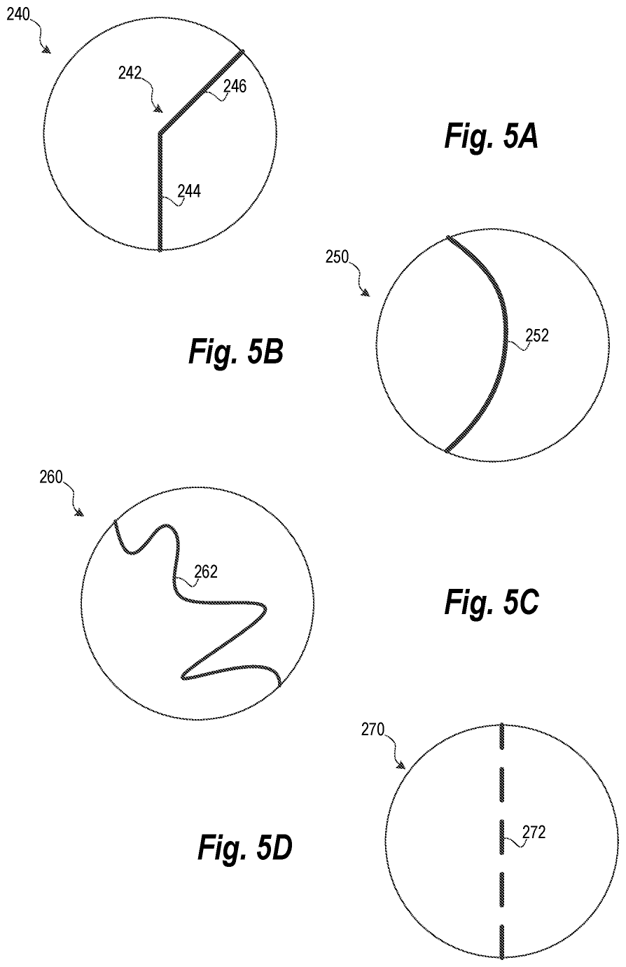

FIGS. 5A-5D include some examples of marking patterns that can be produced by a disclosed printing system. FIG. 5A includes a golf ball 240 and a marking pattern 242. The marking pattern 242 is an example of a continuous linear marking that includes different segments connected at an angle. The marking pattern 242 includes a first segment 244 and a second segment 246. A disclosed printing system may print the first segment 244 by rotating the golf ball 240 while in contact with a stationary marking tool. Then the axis of rotation of the golf ball 240 may be changed and the golf ball 240 again rotated relative to the marking tool to produce the second segment 246.

FIG. 5B includes a golf ball 250 and a marking pattern 252. The marking pattern 252 is an example of a continuous curvilinear marking. A disclosed printing system may produce the marking pattern 252 by continuously varying an axis of rotation of the golf ball 250 at a constant rate. FIG. 5C includes a golf ball 260 and a marking pattern 262. The marking pattern 262 is another example of a continuous curvilinear marking. The marking pattern 262 includes multiple turns in the curvature. A disclosed printing system may produce the marking pattern 262 by continuously varying the axis of rotation of the golf ball 260 at a varying rate and in varying directions.

FIG. 5D includes a golf ball 270 and a marking pattern 272. The marking pattern 272 is an example of a non-continuous linear marking. The marking pattern 272 includes linear segments that are generally aligned and spaced from each other. A disclosed printing system may produce the marking pattern 272 by using a start-stop device to alternately move a marking tool into and out of contact with the golf ball 270 while the golf ball 270 rotates.

The disclosed printing system is not limited to printing marking patterns that are the same as or similar to those shown and it should be understood that more detailed marking patterns are possible. Marking patterns contemplated by the current disclosure can include any combination of size, shape, color, and positioning on the golf ball. Various designs for side stamps, logos, play numbers, name plates, and other indicia can be printed on a golf ball by a disclosed system.

By rotating the golf ball and varying the axis of rotation, any point on the surface of the golf ball can be quickly aligned with the marking tool for printing. Further, by maintaining contact with the marking tool while rotating, a marking pattern can be printed across larger surface areas compared to conventional golf ball printing methods. For example, a marking pattern may include a portion that covers at least 120 degrees around a great circle of the golf ball. Additionally, the disclosed systems allow for control of the marking tool to produce non-continuous marking patterns and/or variations in shape, size, and color. For example, disclosed systems include components configured to change the stationary marking device aligned with the golf ball in order to produce a multi-color marking pattern.

Disclosed embodiments may use any type of marking material (e.g. ink) suitable for printing on a golf ball. There are numerous types of inks available within the printing industry, such as solvent evaporating inks, oxidation curing inks, reactive (catalyst curing or dual-component) inks, baking inks, UV curable inks, sublimation inks, and ceramic and glass inks.

Ultraviolet ink can also be used in the present invention. UV inks are typically cured by means of UV light having wavelengths of from about 180 nm to 380 nm. The advantages of using a UV ink are that they are fast and cure thoroughly, they are easy to use and are not affected by small changes in ambient conditions, they retain constant viscosity (i.e., they do not dry up quickly), and they use smaller amounts of combustible organic solvent, such that little or no solvent fumes escape into the working environment and are, therefore, environmentally safer. Small amounts of solvent may be added to the UV inks for certain application to enable the ink to transfer in a conventional manner.

The inks may optionally contain additives such as binders, reactive prepolymers, thinners, low-viscosity mono and poly-functional monomers, photoinitiators to stimulate polymerization, stabilizing additives, flow control agents, wetting agents, pigments, extenders, or combinations thereof.

A marking pattern may be printed over or under a topcoat layer. After the printing process is complete, a golf ball may be removed to a dry room to finally cure the ink used for the marking pattern. The dry room is maintained at an elevated temperature to aid in drying the marking material.

The thickness of the marking material transferred to a golf ball can be any thickness that is sufficient to provide a clear image of the intended design and can vary with the ink type and color. The thickness of the marking pattern is also influenced by the viscosity of the ink, the marking tool, and environmental factors, such as temperature, humidity, and so on. This thickness can be between about 5 m and 75 m, but is not limited thereto.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The golf balls described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the device in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

1. A golf ball printing system, comprising:
a support mechanism configured to hold a golf ball;
a motion device configured to rotate the golf ball about an axis of rotation,
a rotation control device configured to vary the axis of rotation; and
a printing device comprising a marking tool configured to remain stationary while applying marking material to the golf ball while the golf ball is held in the support mechanism;
wherein the motion device is configured to rotate the golf ball while the marking tool applies marking material to the golf ball to produce a marking pattern on the golf ball.

2. The golf ball printing system of claim 1, wherein the rotation control device is configured to vary the axis of rotation continuously while the motion device is rotating the golf ball.

3. The golf ball printing system of claim 1, wherein the marking tool comprises a marking tip configured to contact a surface of the golf ball while the golf ball is held by the support mechanism.

4. The golf ball printing system of claim 1, wherein the marking tool comprises an ink dispenser.

5. The golf ball printing system of claim 1, further comprising a control unit connected to the motion device, the rotation control device, and the printing device.

6. The golf ball printing system of claim 5, wherein the control unit is configured to control the motion device, the rotation control device, and the printing device to produce the marking on the golf ball.

7. The golf ball printing system of claim 6, further comprising a vision device connected to the processing unit, the vision device configured to detect a relative position of the golf ball, and wherein the processing unit is configured to generate rotation instructions based on the relative position of the golf ball and deliver the rotation instructions to the motion device and the rotation control device.

8. The golf ball printing system of claim 1, wherein the marking comprises a continuous marking.

9. The golf ball printing system of claim 1, further comprising a start-stop device configured to control application of the marking material while the golf ball is rotating to thereby produce a non-continuous marking.

10. The golf ball printing system of claim 1, further comprising a tool control device configured to adjust the marking tool to change the color of the marking material applied to the golf ball.

11. A method for printing a marking on a surface of a golf ball, the method comprising:
receiving, at a design system comprising a processing unit, an intended design for a golf ball marking, the intended design including a shape of the marking and a position of the marking on the golf ball;
generating, by the processing unit, a marking plan based on the shape and position of the golf ball marking of the intended design, wherein the marking plan includes rotation instructions;
placing the golf ball in a support mechanism connected to a motion device configured to rotate the golf ball;
placing the golf ball in contact with a stationary marking tool; and
rotating the golf ball with the motion device based on the rotation instructions to produce the golf ball marking on the golf ball.

12. The method of claim 11, wherein the holder further comprises a rotation control device configured to vary an axis of rotation of the golf ball.

13. The method of claim 12, wherein the axis of rotation is continuously varied while the golf ball is rotated.

14. The method of claim 11, wherein receiving the intended design comprises receiving a design file.

15. The method of claim 14, wherein the design file is a .STL file.

16. The method of claim 11, further comprising intervals of starting and stopping the application of the marking material while the golf ball is rotating in order to produce a non-continuous marking.

17. The method of claim 16, wherein the non-continuous marking comprises segments that are spaced from each other on the surface of the golf ball.

18. The method of claim 11, further comprising changing the stationary marking device to produce a multi-color marking pattern on the golf ball.

19. A golf ball printing system, comprising:
a design system comprising a central processing unit and a modeling unit, the modeling unit configured to receive an intended design of a marking pattern and generate a marking plan comprising rotation instructions and print instructions;
a rotation device connected to the design system and configured to rotate a golf ball about a variable axis of rotation based on the rotation instructions,
a printing device comprising a marking tool configured to apply marking material to the golf ball while the golf ball is rotated by the rotation device; and
a start-stop device connected to the control unit and configured to start and stop the application of the marking material based on the print instructions.

20. The golf ball printing system of claim 19, further comprising a tool control device configured to adjust the marking tool to change the color of the marking material applied to the golf ball.
